(19) United States
(12) Patent Application Publication
(10) Pub. No.: US 2026/0238110 A1
(43) Pub. Date: Aug. 13, 2026

(54) DC-TO-DC CONVERTER FOR A HIGH VOLTAGE SYSTEM THAT OPERATES WITHIN A WIDE VOLTAGE RANGE

(71) Applicant: Eaton Intelligent Power Limited, Dublin 4 (IE)

(72) Inventors: Raja Saha, Kolkata (IN); Alain Fanouillere, Saint Malo (FR); Patrick Herranz, Tassin la Demi Lune (FR); Ousama Osman, Bron (FR)

(21) Appl. No.: 19/153,182

(22) PCT Filed: Jan. 26, 2024
(86) PCT No.: PCT/EP2024/025051

§ 371 Date: Aug. 1, 2025

(30) Foreign Application Priority Data
Feb. 2, 2023 (IN) 202311006690

(51) Int. Cl. H02M 1/00; B60L 53/20; H02M 1/088; H02M 3/00; H02M 3/158; H02M 3/335

(52) U.S. Cl. CPC H02M 1/0043; H02M 1/088; H02M 3/015; H02M 3/1582; H02M 3/33573; H02M 3/33584; B60L 53/20; B60L 2210/10

(57) ABSTRACT

A method for operating a bi-directional DC-to-DC converter is provided. The DC-to-DC converter can transfer energy from a high voltage network to a low voltage battery as well as from the low voltage battery to the high voltage network. The method includes operating the DC-to-DC converter in a buck mode, switching from the buck mode to a boost mode, precharging a high voltage capacitor such that the voltage across the high voltage capacitor reaches a preset voltage while operating the DC-to-DC converter in a first phase of the boost mode, and charging the high voltage capacitor such that the voltage across the high voltage capacitor reaches a setpoint voltage while operating the DC-to-DC converter in a second phase of the boost mode.

### BACKGROUND

DC-to-DC converters are used in automotive applications to supply systems of different voltage levels throughout a vehicle. A common automotive application is to enable DC power from a high voltage battery to be used to supply lower DC voltages that power components such as headlights, interior lights, motorized windows, etc.

For example, a DC-to-DC converter is used in electric or hybrid vehicles, where a high voltage (HV) network having capacitors and a battery of several hundred volts (e.g., 400V or 800V) is used to provide energy to the electric motor, and a low voltage (LV) network having a battery (e.g. 12 V, 24V) is used to supply the control and comfort equipment of the vehicle. Such a DC-to-DC converter is typically inserted between the two HV and LV batteries with galvanic isolation for safety reasons and is used to transform and transfer the energy from the HV battery to the LV battery when the vehicle is running.

### BRIEF SUMMARY

A bi-directional DC-to-DC converter and a method for operating the bi-directional DC-to-DC converter are provided. The DC-to-DC converter can transfer energy from a high voltage network to a low voltage battery as well as from the low voltage battery to the high voltage network. Through certain implementations of the described circuitry and methods, it is possible for the proposed circuit having a nominal high voltage (HV) of 400 V or 800V and nominal low voltage (LV) of 12 V or 24V to operate the DC-to-DC converter within a wide range of high voltage variation.

A method for operating a bi-directional DC-to-DC converter is provided. The DC-to-DC converter includes an LLC converter circuit and a buck converter circuit. The method includes the steps of, operating the DC-to-DC converter in a buck mode, switching from the buck mode to a boost mode, precharging a high voltage capacitor such that the voltage across the high voltage capacitor reaches a preset voltage while operating the DC-to-DC converter in a first phase of the boost mode, and charging the high voltage capacitor such that the voltage across the high voltage capacitor reaches a setpoint voltage while operating the DC-to-DC converter in a second phase of the boost mode.

A bi-directional DC-to-DC converter includes an LLC converter circuit, a buck converter circuit operatively coupled to the LLC converter circuit, and a controller operatively coupled to the DC-to-DC converter to control a bi-directional switching of the DC-to-DC converter from a buck mode to a boost mode.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a conventional configuration for a vehicle application of a DC-to-DC converter.

FIG. 2 illustrates a configuration for a vehicle application of a bi-directional DC-to-DC converter.

FIG. 3 illustrates a schematic diagram of an example implementation for a vehicle application of a DC-to-DC converter for high voltage systems.

FIG. 4 illustrates a method for operating a bi-directional DC-to-DC converter, the DC-to-DC converter in accordance with one embodiment.

### DETAILED DESCRIPTION

A bi-directional DC-to-DC converter and a method for operating the bi-directional DC-to-DC converter are provided. The DC-to-DC converter can transfer energy from a high voltage network to a low voltage battery as well as from the low voltage battery to the high voltage network. Through certain implementations of the described circuitry and methods, it is possible for the proposed circuit having a nominal high voltage (HV) of 400 V or 800V and nominal low voltage (LV) of 12 V or 24V to operate the DC-to-DC converter within a wide range of high voltage variation.

FIG. 1 illustrates a conventional configuration for a vehicle application of a DC-to-DC converter 110. Referring to FIG. 1, when an electric vehicle is running the DC-to-DC converter 110 transforms and transfers the energy one way from the HV battery 102 to the LV battery 108 (see arrow). When the electric vehicle is stationary, the HV battery 102 is disconnected, using switches 104, from the entire high voltage network for safety reasons. Thus, all the high voltage capacitors 106 (collectively referenced in the figure as Chv) on the high voltage network are at zero volts when the vehicle is stationary. Therefore, before each start of the vehicle, to provide energy to the electric motor 114 through inverter 112, the HV battery 102 must be reconnected to the whole of the high voltage networks. However, properly reconnecting the HV battery 102 (e.g., via switches 104) is only possible if the high voltage capacitors 106 of the HV network are charged at the same voltage as the HV battery 102. In the prior art, as shown in FIG. 1, the charge of the high voltage capacitors 106 (Chv) using the HV battery 102 is done with a switch 118 and a resistor 116. However, due to the current through the switch 118 and the voltage across the switch 118, the time and effort of charging the high voltage capacitors 106 has to account for the power loss/energy dissipation (e.g., as heat).

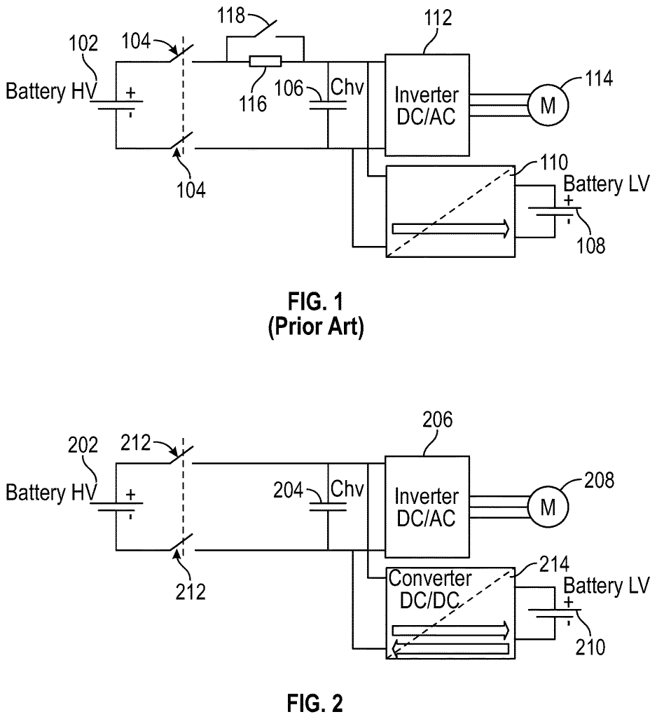

FIG. 2 illustrates a configuration for a vehicle application of a bi-directional DC-to-DC converter 214. Referring to FIG. 2, the energy of the LV battery 210 is used to charge the high voltage capacitors 204 in order to allow the connection of the HV battery 202 to the high voltage network. That is, similar to the configuration of FIG. 1, when an electric vehicle is running, the bi-directional DC-to-DC converter 214 transforms and transfers the energy from the HV battery 202 to the LV battery 210 (see top arrow); and, when the electric vehicle is stationary, the HV battery 202 is disconnected via switches 212. However, unlike the configuration of FIG. 1, before the start of the vehicle, to provide energy to the electric motor 208 through inverter 206, the HV battery 202 is reconnected via switches 212 and the high voltage capacitors 204 are charged by the LV battery 210 using the bi-directional DC-to-DC converter 214 (see bottom arrow). The two-way functionality of the DC-to-DC converter 214 eliminates the need of the resistor 116 and switch 118 shown in the configuration of FIG. 1.

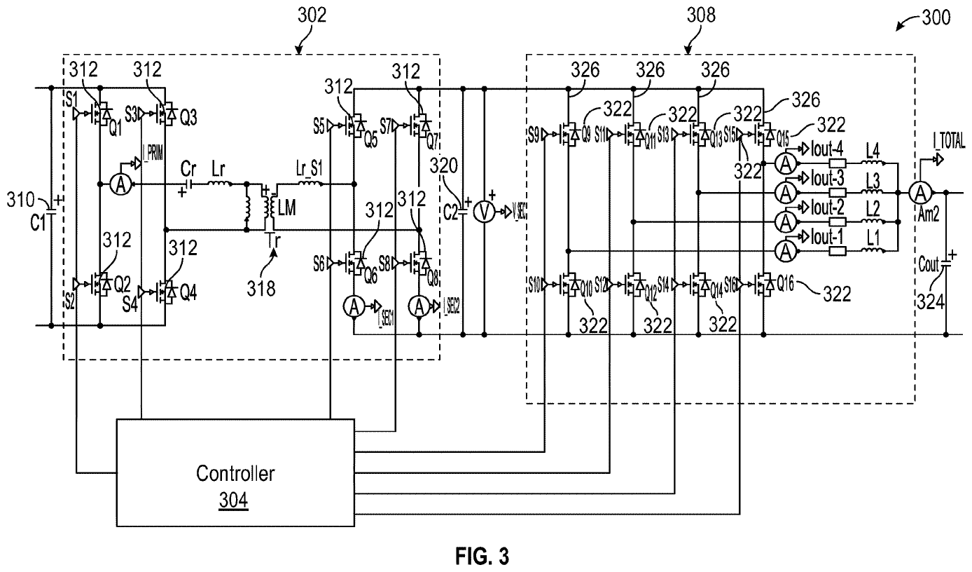

FIG. 3 is a schematic diagram of an example implementation of bi-directional DC-to-DC converter. Referring to FIG. 3, bi-directional DC-to-DC converter 300 includes an LLC converter circuit 302 (LLC, two inductances (L) and a capacitor (C)) and a buck converter circuit 308. A controller 304 can be integrated with the DC-to-DC converter 300 or be a separate component from the DC-to-DC converter 300. The controller 304 can be implemented using one or more processors (executing suitable software instructions), state machines, and/or logic circuits.

The LLC converter circuit 302 includes a transformer 318 and switches 312 (individually labeled as Q1, Q2, Q3, Q4, Q5, Q6, Q7, and Q8). The switches 312 can be semiconductor switches. The LLC converter circuit 302 is a bi-directional full bridge LLC, e.g., inductor (L), inductor (L), capacitor (C), the LLC components together form transformer 318. The LLC converter circuit 302 provides electrical isolation and fixed voltage transfer ratio with high efficiency.

The buck converter circuit 308 is coupled to the LLC converter circuit 302. The buck converter circuit 308 is a bi-directional full bridge circuit. The purpose of the buck converter circuit 308 is to regulate the voltage on the LV side, e.g., the voltage across the low voltage battery 324. The buck converter circuit 308 includes a phase converter, which may be implemented, as shown in FIG. 3, by four interleaved buck converters 326 with a phase shift of 90 degrees. In the shown embodiment, each buck converter 326 comprises two switches 322 positioned in a leg. For example, one leg, as shown in FIG. 3, comprises two switches 322, e.g., Q9 and Q10. Switches 322 (individually labeled as Q9, Q10, Q11, Q12, Q13, Q14, Q15, and Q16) are controlled by controller 304. Switches 322 can be semiconductor switches.

In the schematic example of FIG. 3, four unitary interleaved buck converters 326 are interleaved by 90 degrees, each buck converter 326 designed to deliver 1 kW nominal output power. Utilizing the individual buck converters 326, the output power for the DC-to-DC converter can be scaled from 1 kW to several kW by adding unitary buck converters 326, each delivering 1 kW. The interleaved phase will be defined by 360 degrees divided by the number of interleaved buck converters 326 connected in parallel.

The high voltage capacitor 310 can be charged under the control of controller 304 which operates switches Q1, Q2, Q3, Q4, Q5, Q6, Q7, and Q8. Through operations of the controller 304, the high voltage capacitor 310 can be charged according to the method 400.

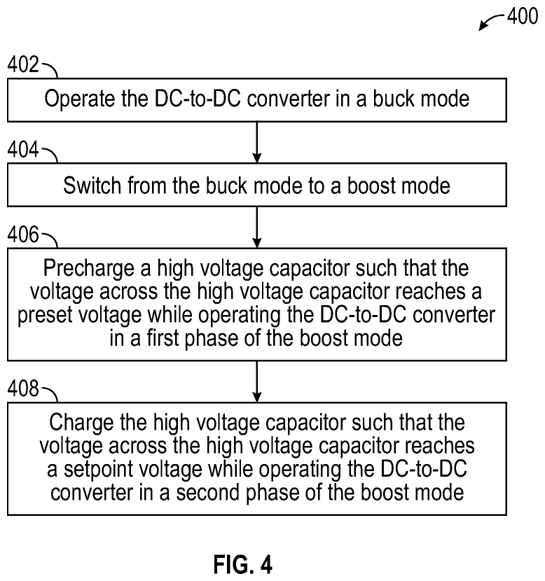

FIG. 4 illustrates a method for operating a bi-directional DC-to-DC converter. Method 400 can be performed when utilizing the LLC converter circuit 302 and the buck converter circuit 308 as described in FIG. 3. Method 400 includes operating (402) the DC-to-DC converter in a buck mode. Method 400 further includes switching (404) from the buck mode to a first boost mode. Method 400 includes precharging (406) a high voltage capacitor such that the voltage across the high voltage capacitor reaches a preset voltage while operating the DC-to-DC converter in a first phase of the boost mode. Method 400 further includes charging (408) the high voltage capacitor such that the voltage across the high voltage capacitor reaches a setpoint voltage while operating the DC-to-DC converter in a second phase of the boost mode. Controller 304 coupled to the DC-to-DC converter 300 can perform the switching and operating steps of method 400.

A bi-directional DC-to-DC converter as described herein can operate in two modes: a buck, or forward, mode, and a boost, or reverse, mode. In buck mode, the energy is transferred from the high voltage side, e.g., high voltage battery 202, to the low voltage side, e.g., the low voltage battery 324. In boost mode, the low voltage battery 324 becomes a source to precharge the high voltage capacitor 310.

When operating (402) the DC-to-DC converter in the buck mode, the DC-to-DC converter 300 can operate to deliver 8-16 V DC across the low voltage battery 324 from an input range of 325-950 V DC across the high voltage capacitor 310. The LLC converter circuit 302 is controlled by controller 304 which operates the switches, Q1, Q2, Q3, Q4, Q5, Q6, Q7, and Q8, so that each one is in an open or closed position, to operate in open loop at the resonant switching frequency.

In buck mode, the LLC converter circuit 302 is controlled by the controller 304 in open loop, e.g., at a resonant switching frequency, fs. The LLC converter circuit 302 includes two resonant frequencies, fr1 and fr2, as shown below. The LLC converter circuit 302 operates such that the resonant switching frequency is in a range (fr2<fs<fr1).

$$fr 1 = 1 \div 2 π \sqrt{LrCr} \qquad ( 1 )$$

$$fr 2 = 1 \div 2 π \sqrt{( Lr + Lm ) Cr} \qquad ( 2 )$$

Operating in open loop at the resonant switching frequency in buck mode, enables the DC-to-DC converter 300 to operate within a wide input voltage range, e.g., 325 V DC to 950 V DC. In open loop, the output voltage of the LLC converter circuit 302, e.g., across capacitor 320, varies linearly with the voltage across the high voltage capacitor 310. In addition, the voltage across capacitor 320 does not vary with the load current. Operating the LLC converter circuit 302 in open loop, optimizes the switching losses and efficiency of the LLC converter circuit 302. For example, when the input voltage is 325 V DC across high voltage capacitor 310 and output voltage is 14V DC across the low voltage battery 324, the efficiency of the DC-to-DC converter 300 is 96.51%.

The DC-to-DC converter 300 can also operate in a boost mode; the boost mode describing a mode where the energy is transferred from the low voltage battery to the high voltage side. Boost mode can include two phases, a first boost phase and a second boost phase. In a first boost phase, or a soft start mode, due to intrinsic body diode of semiconductor device, the voltage across the capacitor 320 is already charged by the low voltage battery at an input voltage of, for example, 14V. In order to limit a high inrush current in the LLC converter circuit 302, the LLC converter circuit 302 is operated in a soft start mode which includes a combination of ramping down a switching frequency of the LLC converter circuit 302 from a ‘double value’ to an original value, along with ramping up of a phase shift or a phase overlap between the two inductors of the transformer 318.

The DC-to-DC converter 300 then enters the second boost phase, a closed loop control mode, where the output of the buck converter circuit 308 includes both a constant current and a constant voltage mode. The voltage across capacitor 320 gradually increases without exceeding a maximum current absorbed from the low voltage battery 324. Due to operating the LLC converter circuit 302 in closed loop and along with the transformer 318 gain, the voltage across the high voltage capacitor 310 is also gradually increased. The voltage of high voltage capacitor 310 is charged up to a reference voltage setpoint. The reference high voltage setpoint is in a range of 325V DC to 950V DC.

Operating the DC-to-DC converter 300 in boost mode, the buck converter circuit 308 will increase the voltage from the low voltage battery 324 across capacitor 320 at the input to the LLC converter circuit 302. Transformer 318 increases the voltage in a ratio from the input of the LLC converter circuit 302 to the high voltage battery. In a first boost phase, the high voltage capacitor 310 is precharged such that the voltage across the high voltage capacitor 310 charges from 0V to up to a few hundred volts DC. In a second boost phase, the high voltage capacitor 310 can be charged until the voltage across the high voltage capacitor 310 reaches a setpoint value that can lie in a range of 325 V DC to 950 V DC.

As described above, DC-to-DC converter 300 is bi-directional, capable of operating in buck mode to deliver 8-16V DC from an input voltage range of 400-800V DC (nominal voltage for HV batteries), and in boost mode to precharge a HV DC bus capacitor up to 950 V DC. Additionally, the DC-to-DC converter can be used to precharge at the high voltage capacitor from 0V to a desired voltage from the energy of the low voltage network.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method for operating a bi-directional DC-to-DC converter, the DC-to-DC converter comprising an LLC converter circuit and a buck converter circuit, the method comprising:
operating the DC-to-DC converter in a buck mode;
switching from the buck mode to a boost mode;
precharging a high voltage capacitor such that a first voltage across the high voltage capacitor reaches a preset voltage in a first phase of the boost mode; and
charging the high voltage capacitor such that the first voltage across the high voltage capacitor reaches a setpoint voltage in a second phase of the boost mode.

2. The method of claim 1, wherein the operating and the switching are performed by a controller coupled to the DC-to-DC converter.

3. The method of claim 1, wherein the LLC converter circuit operates in open loop at a resonant switching frequency in buck mode.

4. The method of claim 1, wherein the buck converter circuit comprises a plurality of interleaved buck converters to regulate a second voltage across a low voltage battery in a range from 8 V DC to 16 V DC.

5. The method of claim 4, wherein the buck converter circuit includes four interleaved buck converters with a phase shift of 90 degrees.

6. The method of claim 1, wherein the preset voltage is up to 950 V DC.

7. The method of claim 3, wherein the setpoint voltage is in a range from 325 V DC to 950 V DC.

8. A bi-directional DC-to-DC converter, comprising:
an LLC converter circuit;
a buck converter circuit operatively coupled to the LLC converter circuit; and
a controller operatively coupled to the DC-to-DC converter to control a bi-directional switching of the DC-to-DC converter from a buck mode to a boost mode.

9. The bi-directional DC-to-DC converter of claim 8, wherein the LLC converter circuit comprises a full bridge converter.

10. The bi-directional DC-to-DC converter of claim 8, wherein the buck converter circuit comprises a full bridge converter.

11. The bi-directional DC-to-DC converter of claim 8, wherein the buck converter circuit comprises a phase converter.

12. The bi-directional DC-to-DC converter of claim 11, wherein the buck converter circuit comprises four interleaved buck converters with a 90-degree phase shift.

13. The bi-directional DC-to-DC converter of claim 12, wherein the four interleaved buck converters each deliver 1 kW of power to a low voltage battery in buck mode.

14. The bi-directional DC-to-DC converter of claim 8, wherein the LLC converter circuit operates in open loop at a resonant switching frequency in the buck mode.

15. The bi-directional DC-to-DC converter of claim 8, wherein the LLC converter circuit comprises a transformer and switches Q1, Q2, Q3, Q4, Q5, Q6, Q7, and Q8.
